(19) United States
(12) Patent Application Publication
(10) Pub. No.: US 2008/0065763 A1
(43) Pub. Date: Mar. 13, 2008

(54) Remote video monitoring system running on blade PC infrastructure

(75) Inventors: Te-Hsien Lai, Taipei Shien (TW); Chin-Tsai Yen, Taipei (TW); Yen-Pin Tung, Taipei Shien (TW); Ming-Chien Yang, Taipei Shien (TW)

Correspondence Address: REED SMITH LLP, Suite 1400, 3110 Fairview Park Drive, Falls Church, VA, 22042, US

(73) Assignee: Quanta Computer Inc.

(21) Appl. No.: 11/878,394

(22) Filed: Jul. 24, 2007

(30) Foreign Application Priority Data
Sep. 8, 2006 (TW) 095133372

(51) Int. Cl. G06F 15/173

(52) U.S. Cl. 709/224

(57) ABSTRACT

The invention is to provide a centralized computer system, i.e., the so-called blade PC system. The centralized computer system according to the invention includes a plurality of centralized and bladed hosts. In particularly, the centralized computer system according to the invention enables two sets of I/O peripherals to operate the same host in a hardware-driven way.

### BACKGROUND OF THE INVENTION

1. Field of the Invention

The invention relates to a centralized computer system, i.e., the so-called blade PC system and, more particularly, to a hardware-driven way for enabling a display of one set of I/O peripherals to video monitor N hosts being operated.

2. Description of the Prior Art

Many commercial businesses and enterprises make extensive use of personal computers (PCs) in their daily operations. In a typical manner, each user of a PC in the enterprise has a networked PC at his/her desk or in the working area. As the number of networked computer systems utilized in an enterprise increases, the management of resources in the network may become increasingly complex and expensive. Therefore, some of the manageable issues involved in maintaining a large number of networked computer systems are required to be taken into consideration, including the ease of installation and deployment, the topology and physical logistics of the network, asset management, scalability (the cost and effort involved in increasing the number of units), troubleshooting network or unit problems, support costs, software tracking and management, the issue of physical space such as space of the floor space or room on the desk, as well as security issues regarding physical assets, information protection, software control, and computer viruses.

To overcome the mentioned-above problems, many IT companies have developed the centralized computer systems. Referring to FIG. 1, FIG. 1 is a schematic diagram illustrating an infrastructure of a typical centralized computer system 1. As shown in FIG. 1, the centralized computer system 1 includes a plurality of hosts 12, where each host 12 is equipped with and operated by a set of peripherals 14 including at least one peripheral device. The hosts 12 in the centralized computer system 1 are bladed, i.e., each of the hosts 12 is implemented into a “card”. In other words, each host 12 comprised on a circuit card includes the components of the standard computer system. The centralized computer system 1 also includes a network 16 to provide the hosts 12 to communicate with the remote peripheral devices. As shown in FIG. 1, each set of peripherals 14 may include a display 142, a keyboard 144, a mouse 146, and/or other peripheral devices for human interface. The centralized computer system 1 communicates with one set of peripherals 14 coupled to the host 12 by sending and receiving encoded I/O signals transmitted via the network 16. In general, a host switch (not shown in FIG. 1), connecting with the I/O interface of a host 12 in the centralized computer system 1. Relatively, each set of I/O peripherals 14 is equipped with a peripheral switch 148 coupled to all of the peripheral devices of the set of I/O peripherals 14. And, the I/O signals transmitted between one host 12 and the assigned set of I/O peripherals 14 are encoded and decoded by the corresponding host switch and the corresponding peripheral switch 148, transmitted via the network 16. The network 16 may be a Local Area Network (LAN), such as an intranet, or a Wide Area Network (WAN), such as the Internet, though other networks are taken into account.

On summary, the distinct features and advantages of the typical centralized computer system are as follows:

(a) the centralized computer system can includes at least ten hosts in a chassis;
(b) because the hosts are bladed to reduce the volume, more hosts can be configured;
(c) because the centralized computer system is a highly integrated system, providing a management host to control and search the whole system is necessary;
(d) the hosts are centralized in the computer room to prevent man-made destruction and information stealing;
(e) by means of the setting of certain software, the user can read and retreat data but copy;
(f) because the hosts are centralized in the computer room, the user won't hear the noise generated by fans;
(g) with the centralized computer system, there are only a keyboard, a mouse, a display and a network connector on the user's desk, i.e., the user has more spatial usability;
(h) with the centralized computer system, two sets of I/O peripherals are enabled to operate the same host;
(i) with the centralized computer system, the manager can seamlessly monitor other hosts without being found out by other users; and
(j) with the centralized computer system, seamlessly broadcasting to all users is much easier.

However, the solutions for enabling a display of a set of I/O peripherals to video monitor N hosts nowadays are all required to utilize software. That is, the host computer and the guest computer all need to install the same application software before the display of the set of I/O peripherals performs video monitoring. And, all processes should be operated under the operating system (OS). In addition, the monitoring function can be operated only when application software supporting the monitoring function is driven.

Accordingly, one scope of the invention is to provide a centralized computer system where a display of one set of I/O peripherals is enabled to video monitor N hosts in a hardware-driven way rather than a software-driven way.

### SUMMARY OF THE INVENTION

The invention is to provide a controlling method used in a centralized computer system. The centralized computer system comprises a network, N hosts, N host switches connecting with the N hosts and linking to the network, N first I/O peripheral switches linking to the network, N first sets of I/O peripherals, a second peripheral switch linking to the network, and a second set of I/O peripherals, wherein N is a natural number. Each first set of I/O peripherals connects to one of the N first peripheral switches. The second set of I/O peripherals connects to the second peripheral switch. The second set of I/O peripherals comprises a display electrically connected to the second peripheral switch. Each first set of I/O peripherals is assigned to operate one of the N hosts, such that a plurality of I/O signals transmitted, via the network, between the host and the assigned first set of I/O peripherals are encoded and decoded by the host switch connecting with the host and the first peripheral switch. In this controlling method, the display of the second set of I/O peripherals is used to video monitor the N hosts.

According to the controlling method of the invention for the centralized computer system, first, at each of the N host switches, a video signal of the I/O signals is down-sampled, the down-sampled video signal is encoded, and then the encoded down-sampled video signal is redirected to the second peripheral switch via the network. Afterward, at the second peripheral switch, the N encoded down-sampled video signals transmitted from the N host switches are received respectively, and the encoded down-sampled video signals are decoded to obtain the N down-sampled video signals. Then, a synthetic video signal is produced by utilizing the N down-sampled video signals, and the synthetic video signal is outputted to the display of the second set of I/O peripherals.

Additionally, the invention is to provide a centralized computer system comprising a network, N hosts, N host switches, N first I/O peripheral switches, N first sets of I/O peripherals, a second peripheral switch, and a second set of I/O peripherals, where N is a natural number. Each of the N host switches connects with one of the N hosts and links to the network. The N first I/O peripheral switches links to the network respectively. Each of the N first sets of I/O peripherals is electrically connected to one of the N first peripheral switches. The second peripheral switch links to the network. The second set of I/O peripherals is electrically connected to the second peripheral switch and comprises a display.

Each first set of I/O peripherals is assigned to operate one of the N hosts, such that a plurality of I/O signals transmitted, via the network, between the host and the assigned first set of I/O peripherals are encoded and decoded by the host switch connecting with the host and the first peripheral switch. Each host switch down-samples a video signal of the I/O signals. Each host switch encodes the down-sampled video signal and redirects the encoded down-sampled video signal to the second peripheral switch via the network. The second peripheral switch receives the N encoded down-sampled video signals transmitted from the N host switches respectively, decodes the encoded down-sampled video signals to obtain the N down-sampled video signals, produces a synthetic video signal by utilizing the N down-sampled video signals, and outputs the synthetic video signal to the display of the second set of I/O peripherals. Whereby, the display of the second set of I/O peripherals is capable of video monitoring the N hosts.

The advantage and spirit of the invention may be understood by the following recitations together with the appended drawings.

### BRIEF DESCRIPTION OF THE APPENDED DRAWINGS

FIG. 1 is a schematic diagram illustrating an infrastructure of a typical centralized computer system;

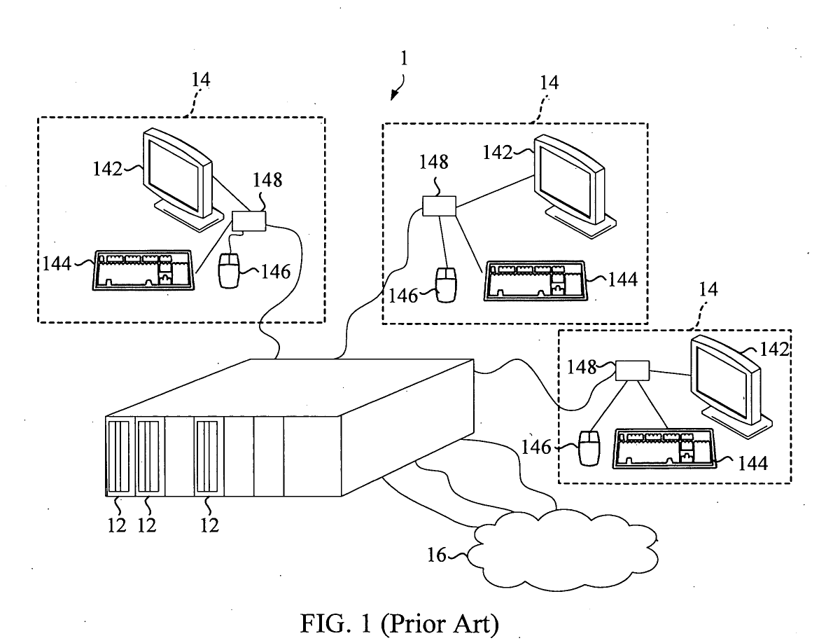

FIG. 2 is a schematic diagram illustrating an infrastructure of a centralized computer system according to a preferred embodiment of the invention; and

FIG. 3 is a schematic diagram illustrating the video signal transmitting paths for a partial infrastructure of a centralized computer system shown in FIG. 2.

### DETAILED DESCRIPTION OF THE INVENTION

The invention is to provide a centralized computer system and a controlling method thereof and, more particularly, under the infrastructure, the invention utilizes a hardware-driven way rather than a software-driven way to enable a display of a second set of I/O peripherals to video monitor N hosts being operated. By the descriptions of the preferred embodiments of the invention in the following, the features, spirits, advantages, and convenience of the implement are illustrated adequately.

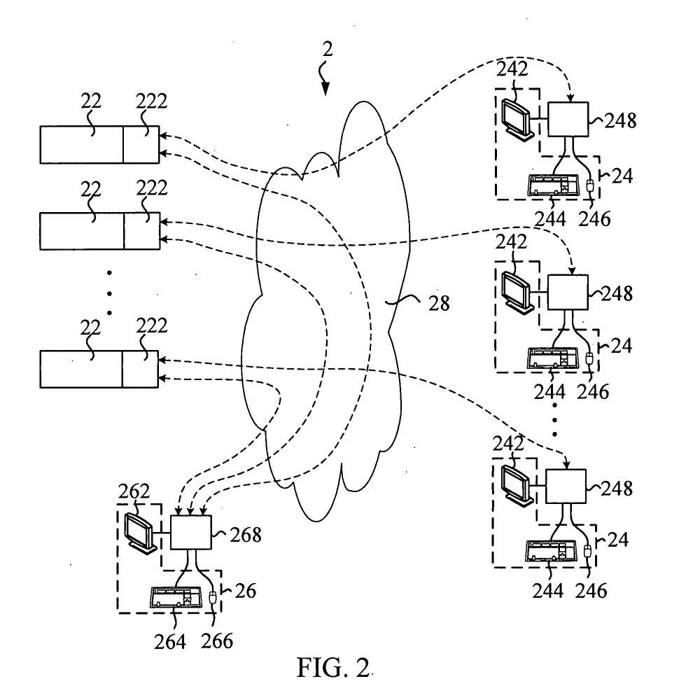

Referred to FIG. 2, FIG. 2 is a schematic diagram illustrating an infrastructure of a centralized computer system 2 according to a preferred embodiment of the invention. As shown in FIG. 2, the centralized computer system 2 comprises a network 28, N hosts 22, N host switches 222, N first I/O peripheral switches 248, N first sets of I/O peripherals 24, a second peripheral switch 268, and a second set of I/O peripherals 26, where N is a natural number. Each of the N host switches 222 connects with one of the N hosts 22 and links to the network 28. The N first I/O peripheral switches 248 and the second peripheral switch 268 link to the network 28 respectively.

As shown in FIG. 2, each of the N first sets of I/O peripherals 24 comprises a display 242 and M first I/O peripheral devices, such as a keyboard 244, a mouse 246, and so on, wherein M is a natural number. Each of the N first sets of I/O peripherals 24 is electrically connected to one of the N first peripheral switches 248.

As shown in FIG. 2, the second set of I/O peripherals 26 comprises a display 262 and P second I/O peripheral devices, such as a keyboard 264, a mouse 266, and so on, wherein P is a natural number. The second set of I/O peripherals 26 is electrically connected to the second peripheral switch 268 and comprises the display 262.

As shown in FIG. 2, each first set of I/O peripherals 24 is assigned to operate one of the N hosts 22, such that a plurality of I/O signals transmitted, via the network 28, between the host 22 and the assigned first set of I/O peripherals 24 are encoded and decoded by the host switch 222 connecting with the host 22 and the first peripheral switch 248 connecting with the assigned first set of I/O peripherals 24.

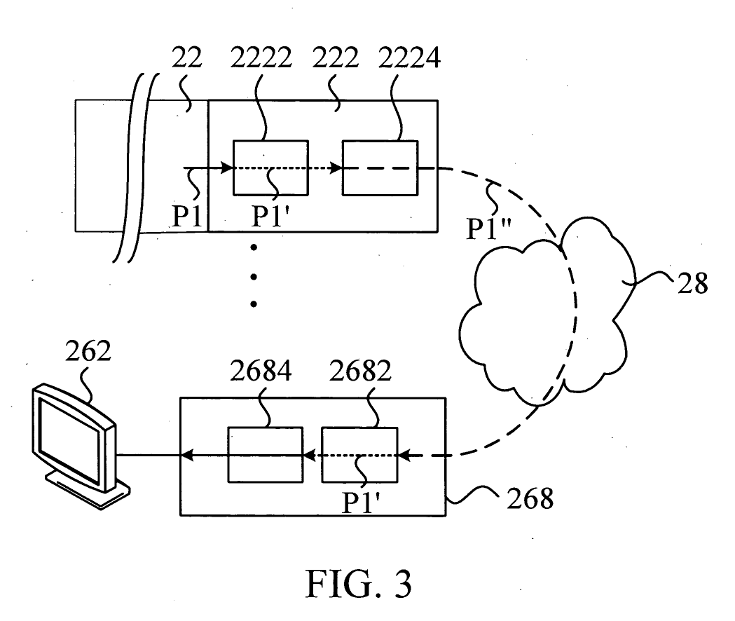

In practical applications, referring to FIG. 3, FIG. 3 is a schematic diagram illustrating a partial infrastructure of the centralized computer system 2 shown in FIG. 2, so as to illustrate transmitting paths of the video signals. As shown in FIG. 3, each host switch 222 utilizes a scaling module 2222 to down-sample a video signal P1 of the I/O signals, utilizes an encoder 2224 to encode the down-sampled video signal P1′, and redirects the encoded down-sampled video signal P1″ to the second peripheral switch 268 via the network 28. The host 22 connecting with the host switch 222 outputs the I/O signals.

The second peripheral switch 268 receives the N encoded down-sampled video signals P1″ transmitted from the N host switches 222 respectively, decodes the encoded down-sampled video signals P1″ to obtain the N down-sampled video signals P1′ by a decoder 2682, utilizes the N down-sampled video signals P1′ to produce a synthetic video signal by a video synthesis module 2684, and outputs the synthetic video signal to the display 262 of the second set of I/O peripherals 26. Whereby, the display 262 of the second set of I/O peripherals 26 is capable of video monitoring the N hosts 22.

In this embodiment, the video signal P1 of the I/O signals outputted by one of the N hosts 22 is down-sampled according to a rate of 1/N.

In this embodiment, the synthetic video signal is produced by utilizing the N down-sampled video signals P1′ on the basis of the physical addresses of the N host switches 222.

According to a preferred embodiment of the invention, a controlling method for the centralized computer system shown in FIG. 2 is illustrated in the following. It should be emphasized that each first set of I/O peripherals 24 is assigned to operate one of the N hosts 22, such that a plurality of I/O signals transmitted, via the network 28, between the host 22 and the assigned first set of I/O peripherals 24 are encoded and decoded by the host switch 222 connecting with the host 22 and the first peripheral switch 248 connecting with the assigned first set of I/O peripherals 24. Particularly, the controlling method is capable of enabling the display 262 of the second set I/O peripherals 26 to video monitor the N hosts 22.

According to the controlling method of the invention, first, at each of the N host switches 222, the scaling module 2222 is used to down-sample the video signal P1 of the I/O signals. The encoder 2224 is used to encode the down-sampled video signal P1′, and the encoded down-sampled video signal P1″ is redirected to the second peripheral switch 268 via the network 28.

Afterward, at the second peripheral switch 268, the N encoded down-sampled video signals P1″ transmitted from the N host switches 222 are received respectively. The decoder 2682 is used to decode the encoded down-sampled video signals P1″ to obtain the N down-sampled video signals P1′. The video synthesis module 2684 is used to produce a synthetic video signal from the N down-sampled video signals P1′, and the synthetic video signal is outputted to the display 262 of the second set of I/O peripherals 26.

Compared to the prior art, according to the centralized computer system 2 and the controlling method thereof, obviously, the invention utilizes the hardware-driven way to enable the display 262 of the second set of I/O peripherals to video monitor the N hosts 22 being operated, so as to avoid the inconvenience of the software-driven way.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A controlling method for a centralized computer system, the centralized computer system comprising a network, N hosts, N host switches connecting with the N hosts and linking to the network, N first I/O peripheral switches linking to the network, N first sets of I/O peripherals, a second peripheral switch linking to the network, and a second set of I/O peripherals, each first set of I/O peripherals connecting with one of the N first peripheral switches, the second set of I/O peripherals connecting with the second peripheral switch, the second set of I/O peripherals comprising a display electrically connecting with the second peripheral switch, N being a natural number, one of the N first sets of I/O peripherals being assigned to operate one of the N hosts such that a plurality of I/O signals transmitted, via the network, between the host and the assigned first set of I/O peripherals are encoded and decoded by the host switch connecting with the host and the first peripheral switch connecting with the assigned first set of I/O peripherals, the controlling method, for video monitoring the N hosts by utilizing the display of the second set of I/O peripherals, comprising steps of:
at each of the N host switches, down-sampling a video signal of the plurality of I/O signals, encoding the down-sampled video signal, and redirecting the encoded down-sampled video signal to the second peripheral switch via the network; and
at the second peripheral switch, receiving the N encoded down-sampled video signals transmitted from the N host switches respectively, decoding the encoded down-sampled video signals to obtain the N down-sampled video signals, producing a synthetic video signal by utilizing the N down-sampled video signals, and outputting the synthetic video signal to the display of the second set of I/O peripherals.

2. The controlling method of claim 1, wherein the video signal of the plurality of I/O signals outputted by each of the N hosts is down-sampled according to a magnification factor of 1/N.

3. The controlling method of claim 1, wherein the synthetic video signal is produced by utilizing the N down-sampled video signals on the basis of the physical addresses of the N host switches.

4. A centralized computer system, comprising:
a network;
N hosts, N being a natural number;
N host switches, each of the N host switches connecting with one of the N hosts and linking to the network;
N first peripheral switches, the N first peripheral switches linking to the network respectively;
N first sets of I/O peripherals, each of the N first sets of I/O peripherals electrically connecting with one of the N first peripheral switches;
a second peripheral switch, linking to the network; and
a second set of I/O peripherals, electrically connecting with the second peripheral switch and comprising a display;
wherein one of the N first sets of I/O peripherals is assigned to operate one of the N hosts such that a plurality of I/O signals transmitted, via the network, between the host and the assigned first set of I/O peripherals are encoded and decoded by the host switch connecting with the host and the first peripheral switch connecting with the assigned first set of I/O peripherals;
wherein each host switches down-samples a video signal of the plurality of I/O signals, encodes the down-sampled video signal, and redirects the encoded down-sampled video signal to the second peripheral switch via the network, and the second peripheral switch receives the N encoded down-sampled video signals transmitted from the N host switches respectively, decodes the encoded down-sampled video signals to obtain the N down-sampled video signals, produces a synthetic video signal by utilizing the N down-sampled video signals, and outputs the synthetic video signal to the display of the second set of I/O peripherals; and
whereby the display of the second set of I/O peripherals is enabled to video monitor the N hosts.

5. The centralized computer system of claim 4, wherein the video signal of the plurality of I/O signals outputted by each of the N hosts is down-sampled according to a magnification factor of 1/N.

6. The centralized computer system of claim 4, wherein the synthetic video signal is produced by utilizing the N down-sampled video signals on the basis of the physical addresses of the N host switches.
